(19) United States
(12) Patent Application Publication
(10) Pub. No.: US 2009/0262378 A1
(43) Pub. Date: Oct. 22, 2009

(54) Image Modification for Improved Printing and Cutting of the Image

(76) Inventor: Orion Seth Jensen, Cedar Park, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/104,775

(22) Filed: Apr. 17, 2008

(51) Int. Cl. G06K 15/00

(52) U.S. Cl. 358/1.12

(57) ABSTRACT

Preparing an image for printing and/or cutting of a material comprising the image. An original image may be received. Versions of the image may be drawn over the original image. The versions of the image may be translated relative to the original image, but the original image may be unmodified with respect to any overlapping portions of the versions of the image. Drawing the versions of the image over the original image may produce a modified image. The modified image may be stored and may be usable for printing and/or cutting.

### FIELD OF THE INVENTION

The present invention relates to the field of image modification and/or image printing, and more particularly to a system and method for modifying an image for improved printing and cutting of the image.

### DESCRIPTION OF THE RELATED ART

Current printing and cutting systems often produce finalized printed (or cut) images which have errors, such as undesired white space. For example, when printing a sign or poster on a pre-sized material, if the printer's alignment is off, there can be white spaces in the final printed sign or poster where the printer failed to print. Similarly, if a printed image should be cut (e.g., for decals or sticker images), the cutting device may be off in alignment or precision for the specified borders of the image. Accordingly, when the cut is made imprecisely or incorrectly, the final product may not have the desired appearance.

Some prior art systems have addressed this problem by using materials of the color of the background of the image or by overprinting the background color well outside the border of the image. However, such systems can be costly and inefficient (e.g., due to the variety of required materials and because of wasted printing ink) and may not properly address images without uniform backgrounds. Correspondingly, improvements in modification of images to be printed and/or cut are desired.

### SUMMARY OF THE INVENTION

Various embodiments of the invention relate to a system and method for preparing an image for printing and/or cutting of a material containing the image.

The method may include receiving an original image, e.g., over a network such as the Internet. The original image may then be modified to produce a modified image in order to prepare the image for printing and/or cutting. For example, versions of the image may be drawn over the original image which are translated relative to the original image. The degree of translation for the versions of the image may be based on the material on which the image is to be printed and/or cut.

Drawing the versions of the image over the original image may include performing a plurality of draw commands in a specified sequence. The draw commands may include move and draw commands (e.g., move to a specific point and redrawing a version of the original image over the original image). In one embodiment, drawing versions of the image over the original image may include drawing diagonal translated versions of the image before drawing horizontal and vertical translated versions of the image. In one embodiment, one or more of the versions of the image may not include one or more elements of the original image.

Alternatively, or additionally, producing the modified image may include copying the original image a plurality of times to produce a plurality of copied images. The plurality of copied images may be overlaid on the original image, which creates the modified image in memory. The locations of the perimeters of the copied images and the original images may be different. Similar to above, overlaying the plurality of copied images may include overlaying each of the plurality of copied images on the original image in a plurality of different directions (e.g., by translating the copied image with respect to the location of the original image), which results in a modified form of the image in memory.

In one embodiment, the plurality of drawn versions and/or copied images may include at least 4 copied images. A first drawn/copied image of the plurality of copied images may be the original image moved diagonally upwards and left. A second drawn/copied image may be the original image moved diagonally upwards and right. A third drawn/copied image may be the original image moved diagonally downwards and left. A fourth drawn/copied image may be the original image moved diagonally downwards and right.

In another embodiment, the plurality of drawn versions and/or copied images may include at least 8 copied images. Four of the drawn/copies images may be moved diagonally as described above. A fifth drawn/copied image may be the original image moved vertically upwards. A sixth drawn/copied image may be the original image moved vertically downwards. A seventh drawn/copied image may be the original image moved horizontally left. An eighth drawn/copied image may be the original image move horizontally right. However, it should be noted that the sequencing of the draw commands and/or copy overlays may vary, e.g., the diagonal copies may be applied before the horizontal and vertical translations, or vice versa.

The original image may be preferably unmodified with respect to any of the overlapping portions of the versions of the image. In one embodiment, in order to cause the original image to be unmodified with respect to any overlapping portions of the versions of the image, the original image may be drawn over the versions of the image to produce the modified image. In other words, the drawing or overlay of the original image may be the last step in the sequence, to ensure that the original image (e.g., image pixels) are unmodified relative to the previous draw/overlay commands. The modified image may be larger than the original image when produced.

The method may further include printing the modified image and/or cutting the modified image along the border of the original image.

Various portions of the method may be performed by a computer server communicating with a client computer. The computer server may include a memory medium which stores program instructions to perform the method described above. The server may be coupled to various printing and cutting devices, as desired.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system according to an embodiment of the present invention;

FIG. 1B illustrates a network system comprising two or more computer systems configured to implement some embodiments of the present invention;

FIG. 2 is a flowchart diagram illustrating an embodiment of a method for modifying an image before printing and/or cutting, according to one embodiment; and

FIGS. 3-4B are exemplary illustrations corresponding to the method of FIG. 2.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C#, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Sign—the term “sign” is intended to have the full breadth of its ordinary meaning in the context of a physical medium which displays static text and/or images. The physical medium may be a stiff medium (e.g., cardboard, plastic, wood, or metal), a flexible medium (e.g., paper), an adhesive medium (e.g., stickers or magnetics), and/or other type of physical medium. Generally, signs may be larger than a typical display screen. Additionally, the text and/or images may convey a message or meaning to a customer or person. For example, a sign may include advertisement information for attracting potential customers (e.g., billboards), personal opinion(s) (e.g., in a bumper sticker), political information (e.g., advocating a particular politician), child information (e.g., identifying achievements and/or memberships of children), and/or other information. Examples include billboards, yard signs, bumper stickers, window signs, banners, magnetics, real estate signs, parking signs, street signs, license plates, etc.

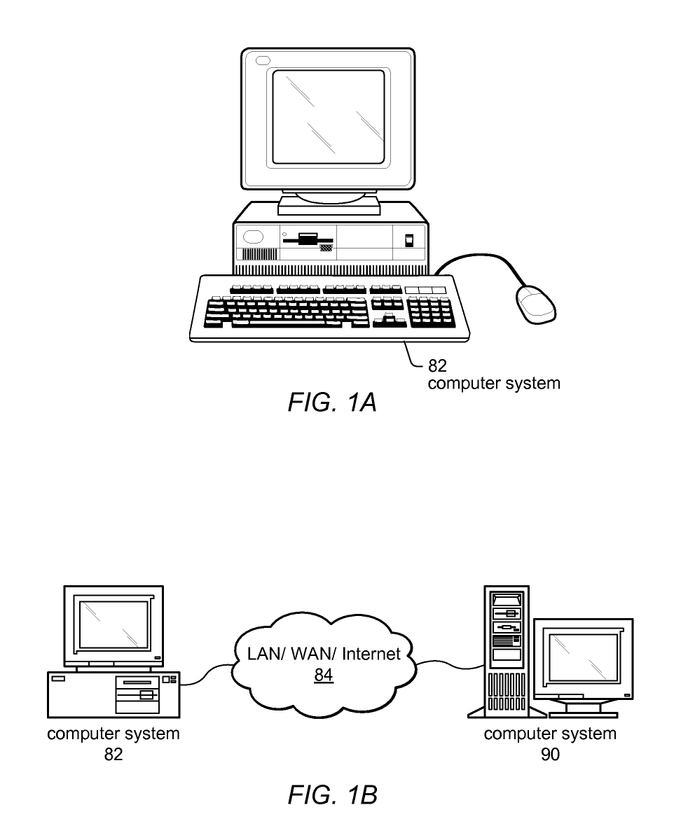

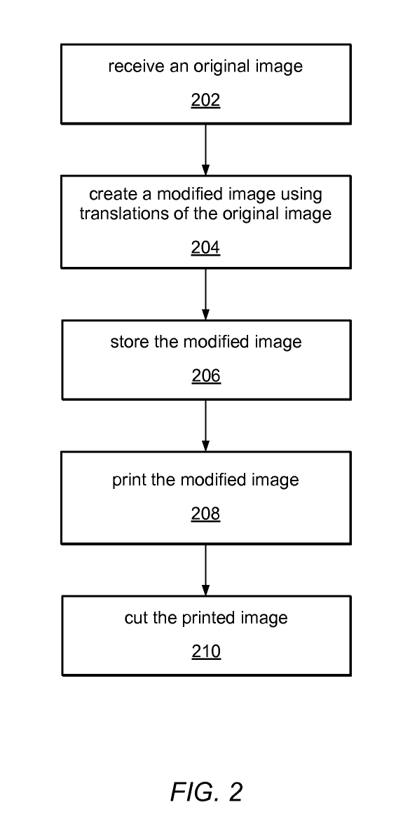

### FIG. 1A—Computer System

FIG. 1A illustrates a computer system 82 operable to perform various embodiments described herein. The computer system 82 may include at least one memory medium on which one or more computer programs or software components according to one embodiment of the present invention may be stored. For example, the memory medium may store one or more programs which are executable to perform the methods described herein. The memory medium may also store operating system software, as well as other software for operation of the computer system. Various embodiments further include receiving or storing program instructions (e.g., in a memory medium) and/or data implemented in accordance with the foregoing description upon a carrier medium.

As shown in FIG. 1A, the computer system 82 may include a display device operable to display a graphical user interface (GUI) of the one or more programs stored/executed by the computer system. For example, the computer system may execute a web browser and display various web pages (such as those described herein) on the display device.

### FIG. 1B—Computer Network

FIG. 1B illustrates a network system comprising two or more computer systems configured to implement some embodiments of the present invention. As shown, the system includes a first computer system 82 that is coupled to a second computer system 90. The computer system 82 may be coupled via a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute a program or web application in a distributed fashion. For example, computer 82 may execute a first portion of the web application and computer system 90 may execute a second portion of the web application. As another example, computer 82 may display a web page stored on the computer system 90. In this example, the computer system 90 may store and execute web server software to present a website that the client computer 82 may access, e.g., over the Internet. The computer system 90 may be configured to perform any of the methods described below. Thus, in various embodiments, the computer system 82 may be a client computer system and the computer system 90 may be a server computer system which provides content or applications to the computer system 82.

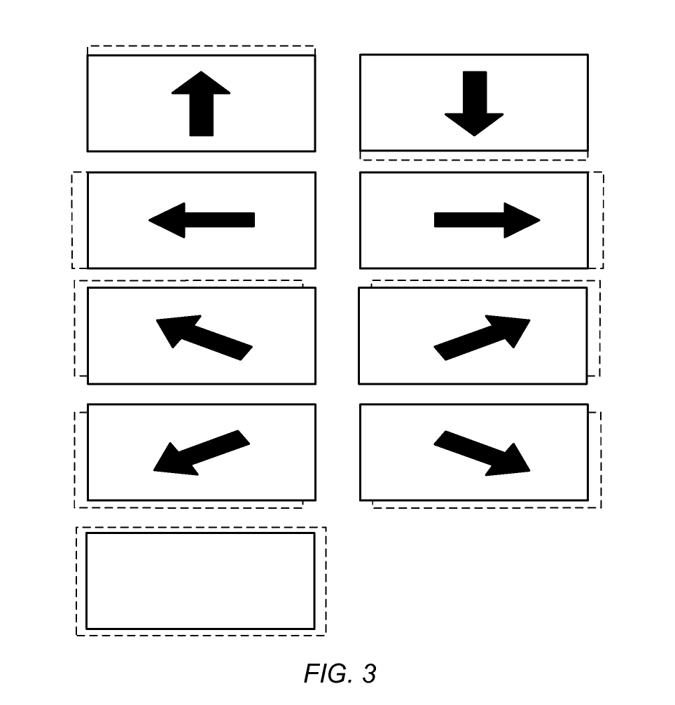

### FIG. 2—Method for Modifying Image

FIG. 2 illustrates a method for modifying an image for improved printing and cutting of the image. The method shown in FIG. 2 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 202 an original image may be electronically received. The original image may be any of various formats including jpeg, bitmap, png, gif post script, portable document format, and/or other formats. The original image may include one or more vector images and/or pixel images, as desired.

In some embodiments, the original image may be received over a network, e.g., to a server computer system (such as the computer system 90) from a client computer system (such as the computer system 82). Additionally, or alternatively, a client may use web services of a web site (e.g., on the server computer system) to create an image. The image may be received by a server computer system coupled to servers of the web site (or the image may be simply manipulated as below using web servers). As another alternative, the image may be scanned from a hard copy of the image.

The original image may have been created using software executing on the client computer system (e.g., using image software executing on the client computer system). Alternatively, or additionally, the image may be created and/or manipulated using software executing on the server computer system (e.g., via interaction of the client system with web service provided by the server). In one embodiment, a user may use the client computer system to access a web site with which the server is associated. The user may provide text input and/or graphics to produce the original image. In some embodiments, the server system may provide a plurality of clip art images for use in the creation of the original image. After production of the original image, it may be received, e.g., by the server.

The original image may correspond to various objects. For example, the original image may correspond to a sign that a customer may wish to have printed. In some embodiments, the original image (when it is a sign) may be a rectangular image which may include a background color or image and one or more foreground images. Alternatively, the original image may correspond to decals or stickers, such as vinyl letters which may need to be printed and then cut. In some embodiments, the original image of the stickers may simply be the individual portions of the image. For example, in the case of text (or individual letters) to be printed and cut, the original image may be the text itself (e.g., not including the background behind the letters). More specifically, in the case of the text “High School Senior”, the original image may simply be the combination of the graphical representations of the letters in the text without a transparent background. This original image representation for different types of objects may be especially useful in the steps described below, as will be discussed.

In 204, a modified image may be produced using the original image (e.g., by the server computer system). The modified image may be created using a variety of methods.

For example, in one embodiment, versions of the original image may be drawn over the original image, where the versions of the image are translated relative to the original image, e.g., the original image may be redrawn at a position that is translated or moved from the original position. The translations may be horizontal, vertical and/or diagonal translations, among others. The drawing may be performed by the server system executing a drawing program and/or using an API of a drawing program to manipulate the original image.

In some embodiments, one or more versions of the original image may exclude certain elements of the original image. For example, the versions of the image may not include elements of the original image based on locations of the elements, e.g., any complicated elements or text located near the edge of the original image. Alternatively, or additionally, specific elements may be removed from the versions of the image regardless of their location. For example, text elements or specific clip art images (e.g., from a plurality of different clip art images which may be supplied by the server computer system) may not be present in the some or all of the versions of the image.

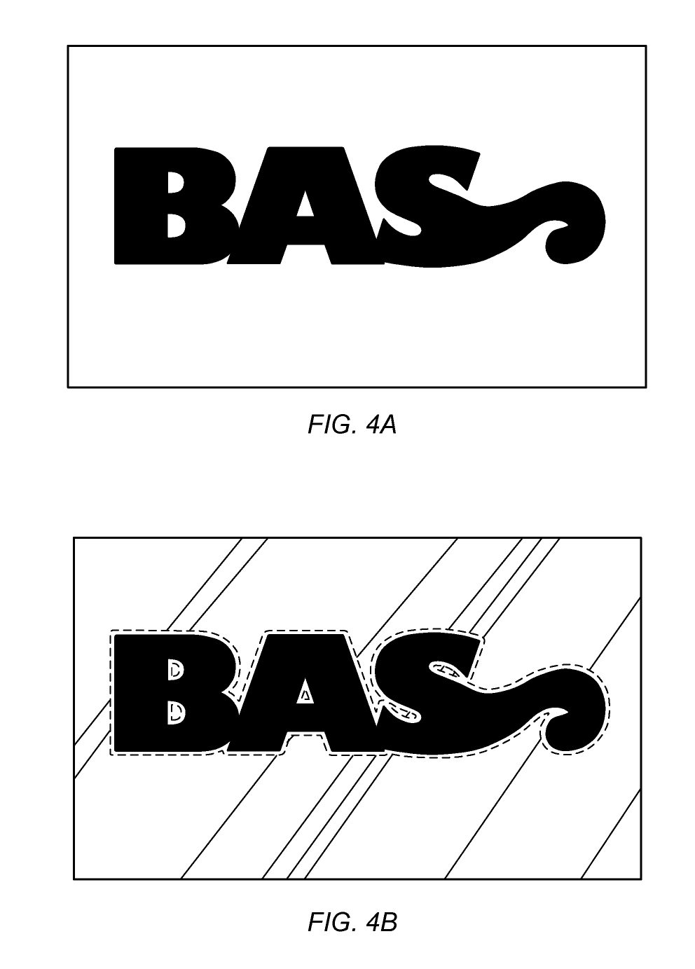

FIG. 3 illustrates an example of the translation of the original image. Note that the arrows shown in FIG. 3 indicate the direction of translation and do not correspond to the original image itself. As shown from the top left to the bottom right, the original image may be translated vertically up, vertically down, horizontally left, horizontally right, diagonally up and left, diagonally up and right, diagonally down and left, diagonally down and right, and then return to the original position. As shown, the resulting final image, referred to herein as the “modified image”, includes the unmodified original image with vertical, horizontal, and diagonal extensions. Note that this image may also correspond to the overlaying of copied images described below.

However, it should be noted that the order of drawing the versions of the image may be important, e.g., in embodiments where each successive draw overwrites portions of the previous draws. For example, drawing the versions of the original image may include performing a plurality of draw commands in a specified sequence. The draw commands may include move and draw commands. The following is exemplary pseudo code of one particular sequence that may be used:

//Shake(UPRight)
imageShakeCopy1.Move(shakeAmount,−shakeAmount)
imageShakeCopy1.Draw( )
//Shake( DownRight )
imageShakeCopy2.Move( shakeAmount, shakeAmount)
imageShakeCopy2.Draw( )
//Shake( UpLeft )
imageShakeCopy3.Move( −shakeAmount, −shakeAmount)
imageShakeCopy3.Draw( )
//Shake( DownLeft )
imageShakeCopy4.Move( −shakeAmount, shakeAmount)
imageShakeCopy4.Draw( )
//Shake( Down )
imageShakeCopy5.Move( 0, shakeAmount)
imageShakeCopy5.Draw( )
//Shake( Up )
imageShakeCopy6.Move( 0, −shakeAmount)
imageShakeCopy6.Draw( )
//Shake( Right )
imageShakeCopy7.Move( shakeAmount, 0)
imageShakeCopy7.Draw( )
//Shake( Left )
imageShakeCopy8.Move( −shakeAmount, 0)
imageShakeCopy8.Draw( )
OriginalImage.Move(0,0)
OriginalImage.Draw( )

Thus, as shown, in some embodiments drawing the versions over the original image may include drawing diagonal translated versions before horizontal and/or vertical translated versions. This may be particularly useful in ensuring that the final modified image has correct extensions of the original image in the horizontal and vertical directions. Said another way, in cases where each successive drawing overwrites the previous drawing, drawing the horizontal and vertical translations after the diagonal translations may result in the extensions to the left, right, top, and bottom to be the result of the horizontal and vertical translations rather than diagonal translations (the horizontal and vertical translations would effectively “trump” the diagonal translations). This may be beneficial in matching colors between the border of the original image and the border of the extensions. Note that the diagonal translations may still have an effect in the corner extensions in this embodiment.

Alternatively, or additionally, to produce the modified image, a plurality of copies of the original image may be generated. Each of the plurality of copied images may be overlaid on the original image, where the locations of the perimeters of the copied images and the original image may be different. In other words, the overlaid images may be translated with respect to the original image. The plurality of copied images may be each overlaid over the original image in a plurality of different directions, e.g., as different translations. Similar to above, generating and overlaying the plurality of copies of the image may be performed by the server computer and may include executing an image manipulation program.

In one embodiment, the plurality of drawn/copied images may include at least 4 drawn/copied images. A first drawn/copied image may be the original image moved diagonally upwards and left. A second drawn/copied image images may be the original image moved diagonally upwards and right. A third drawn/copied image may be the original image moved diagonally downwards and left. A fourth drawn/copied image may be the original image moved diagonally downwards and right.

In one embodiment, the plurality of drawn/copied images may include at least 8 drawn/copied images. Four of the drawn/copied images may be translated in diagonal directions as described above. A fifth drawn/copied image may be the original image moved vertically upwards. A sixth drawn/copied image may be the original image moved vertically downwards. A seventh drawn/copied image may be the original image moved horizontally left. An eighth drawn/copied image may be the original image move horizontally right. However, it should be noted that the first four and the second four could be different than those described above. For example, the first four could be horizontal and vertical translations while the second four could be diagonal, among other possible translations.

However, similar to drawing the images above, the order of the overlaying may be important. For example, diagonally translated copies may be overlaid before horizontally or vertically translated copies.

In a further embodiment, the modified image may be generated by executing a software image processing method that calculates and adds additional image pixels and/or extends vector image portions outside of the original image. The software image processing method may calculate additional image pixels as if the pixels were generated from each of a plurality of drawn and/or overlaid translated versions of the image which are not included within the boundaries of the original image, as described herein. In other words, instead of performing draw/copy-overlay operations to generate the additional pixels for the modified image, the software method may calculate these pixels using an image processing algorithm.

In embodiments described above (e.g., overlaying copied images or drawing versions), among other possible approaches, the degree of translation for the copied images or versions of the image may be determined based on various factors. In one embodiment, the degree of translation may be determined based on the image size, e.g., the translation may be a percentage amount of the image size. Alternatively, or additionally, the translation amount may be a fixed amount (e.g., measured in pixels, inches, or other units). In one embodiment, the translation amount may be determined based on the material the image is to be printed on. For example, for images that are to be printed on Corex, the amount of translation may be 0.375 inches (among other possibilities). Other materials may have other values. For example, aluminum or magnetic materials may only have 0.25 inches of translation. For vinyl, the translation may only be 2 pixels or 0.027 inches.

The degree of translation may also depend on the type of printing or cutting that is to be performed. For example, for signs or posters (e.g., or any rectangular medium), a certain value or formula of translation may be used, but for images to be cut out (e.g., letters in vinyl lettering) a different value or formula may be used.

Note that in producing the modified image, the original image may be unmodified with respect to any overlapping portions of the versions of the image in the modified image. In one embodiment, e.g., where versions of the image are drawn over previous versions, this may be achieved by drawing the original image over the versions of the image, e.g., as a final step. In embodiments where copies of the image are overlaid, the original image may be the overlaid over the plurality of copies, e.g., in a final step. Alternatively, or additionally, the versions of the image may be set as “transparent” and/or the original image may be set as “opaque” to ensure that the original image portion of the modified image is not modified for future printing and cutting. The modified image may be larger than the original image (e.g., because the perimeter of the original image may be extended by the perimeters of the plurality of copies or drawn images described above).

Additionally, note that producing the modified image may be performed differently depending on the desired product and/or the nature of the original image. For example, where the original image includes a defined background (e.g., in the case of a sign), the interior portions of the original image may not be affected by the translations (whether via different drawn versions or overlaid copies). More specifically, since the original image includes a background and is unmodified with respect to the other versions or copies, the interior portion (e.g., the text in the interior portion) may not be affected by the translations (e.g., extending the borders of the text in the interior). Accordingly, this may be especially useful in cases where the user desired to print the original image on a pre-cut or pre-sized material (e.g., as a sign). In this case, the extensions allow there to be little or no white space in the final printed product, even in cases where the printer is misaligned with respect to the position of the material, is not calibrated correctly, or otherwise does not print in the desired manner.

Alternatively, where the original image includes a transparent background (e.g., in the case of stickers or letters to be printed, as indicated above), each portion (e.g., each letter) of the original image may be affected by the translations. Thus, using the example above where the desired letters to be printed are “High School Senior”, each individual letter may be affected by the translations (e.g., expanding each letter's size). Accordingly, this may be especially useful in cases where each portion of the original image is to be printed and/or cut. In this case, the extensions of the individual portions allow there to be little or no white space in the final cut product. Note that as used herein, the term “cut” or “cutting” may refer to a complete cut where, for example, the letters are cut into individual materials corresponding to each letter or to cutting which allows the client to remove the original image letters from the printed material (e.g., in the case of stickers, the client can remove the final sticker from the cut material).

FIGS. 4A and 4B illustrate an example where the original image includes a transparent background with a graphic corresponding to the letters “BAS”. FIG. 4A illustrates the original image and FIG. 4B illustrates the modified image. The diagonal lines indicate the transparent background and the dashed lines indicate the extensions to the original image. In this case, as indicated above, because the original image included a transparent background, the individual letters of the original image are extended. Were the background not transparent, e.g., as in the case of a sign, the letters BAS would not be extended as shown in FIG. 4B. Note that during printing, the shown white space between the letters and the dotted lines would be printed in the colors resulting from the translations. For example, were the letter B blue, and the last translation horizontally left, the area to the left of the B between the border of the original B and the dotted line would be blue. However, in this case, were the letter A red, the small overlapping portion between the B and the A outside of the original letters would be red. However, as indicated above, it should be noted that no part of the original images would be modified. Thus, all of the original letter B would be blue and all of the original letter A would be red.

In 206, the modified image may be stored. The modified image may be stored in a memory medium, e.g., of the client and/or the server. The modified image may be usable for printing and/or cutting as in 208 and 210 below.

In 208, the modified image may be printed on a material. The modified image may be printed in response to a command from the server or client computer system, e.g., by a printing device coupled to the client and/or server computer system. As indicated above, the material may be any of various types, e.g., Corex, magentics, aluminum, vinyl, etc. As also indicated above, the material may be pre-sized for a specific product, such as signs.

In 210, the printed image may be cut. The printed image may be cut in response to a command from the server or client computer system, e.g., by a cutting device coupled to the client and/or server computer system. For example, in the case of lettering and/or stickers, the printed image may be cut in such a way that the client may remove the sticker from the material. The cutting may be performed on or along the borders of the original image, e.g., on the interior of the extensions in the modified image.

Note that while embodiments of the present invention are described regarding signs, similar techniques apply to many other industries. More specifically, embodiments of the present invention may relate to any process involving modification images which may be manifested on a medium (e.g., printed on a physical medium).

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer accessible memory medium storing programming instructions for preparing an image for printing and/or cutting of a material comprising the image, wherein the program instructions are executable by a processor to:
receive an original image;
draw versions of the image over the original image, wherein the versions of the image are translated relative to the original image, wherein the original image is unmodified with respect to any overlapping portions of the versions of the image, and wherein said drawing produces a modified image;
store the modified image, wherein the modified image is usable for printing and/or cutting.

2. The memory medium of claim 1, wherein said drawings comprises performing a plurality of draw commands in a specified sequence, wherein the plurality of draw commands comprise move and draw commands.

3. The memory medium of claim 1, wherein said drawing versions over the original image comprises drawing diagonal translated versions before horizontal and vertical translated versions.

4. The memory medium of claim 1, wherein said drawing versions over the original image comprises drawing the original image over the versions of the image to produce the modified image, wherein drawing the original image over the versions of the image causes the original image to be unmodified with respect to any overlapping portions of the versions of the image.

5. The memory medium of claim 1, wherein the degree of translation in said drawing is based on the material on which the image is to be printed and/or cut.

6. The memory medium of claim 1, wherein the modified image is larger than the original image.

7. The memory medium of claim 1, wherein one or more of the versions of the image do not include one or more elements of the original image.

8. The memory medium of claim 1, wherein the program instructions are further executable to:
print the modified image.

9. The memory medium of claim 8, wherein the program instructions are further executable to:
cut the modified image along the border of the original image.

10. A method for preparing an image for printing and/or cutting of a material comprising the image, comprising:
receiving an original image;
copying the original image a plurality of times to produce a plurality of copied images;
overlaying the plurality of copied images on the original image, wherein locations of the perimeters of the copied images and the original image are different, wherein the original image is unmodified with respect to any overlapping portions of the copied images, and wherein said overlaying the copied images on the original image produces a modified image;
storing the modified image, wherein the modified image is usable for printing and cutting.

11. The method of claim 10, wherein said overlaying the plurality of copied images comprises overlaying each of the plurality of copied images on the original image in a plurality of different directions.

12. The method of claim 10, wherein said overlaying the plurality of copied images comprises overlaying each of the plurality of copied images on the original image in a plurality of different directions by a percentage amount of the dimensions of the original image.

13. The method of claim 10, wherein the plurality of copied images comprise at least 4 copied images, wherein a first copied image of the plurality of copied images is the original image moved vertically upwards, wherein a second copied image of the plurality of copied images is the original image moved vertically downwards, wherein a third copied image of the plurality of images is the original image moved horizontally left, and wherein a fourth copied image of the plurality of images is the original image move horizontally right.

14. The method of claim 13, wherein the plurality of copied images comprise at least 8 copied images, wherein a fifth copied image of the plurality of copied images is the original image moved diagonally upwards and left, wherein a sixth copied image of the plurality of copied images is the original image moved diagonally upwards and right, wherein a seventh copied image of the plurality of copied images is the original image moved diagonally downwards and left, wherein an eighth copied image of the plurality of copied images is the original image moved diagonally downwards and right.

15. The method of claim 10, wherein said overlaying the plurality of copied images comprises translating the copied images with respect to the original image, and wherein the degree of translation in said overlaying is based on the material on which the image is to be printed and/or cut.

16. The method of claim 10, wherein the modified image is larger than the original image.

17. The method of claim 10, wherein one or more of the plurality of copied images do not include one or more elements of the original image.

18. A memory medium for preparing an image for printing and cutting of a material comprising the image, comprising:
receiving an original image, wherein the original image comprises a plurality of original image pixels;
generating a modified image, wherein the modified image comprises the plurality of original image pixels, where the modified image comprises additional image pixels, wherein the additional image pixels are obtained by overlaying a plurality of translated versions of the image onto the original image, wherein the additional image pixels comprise image pixels from each of the overlaid translated versions of the image that are not comprised within boundaries of the original image;
storing the modified image, wherein the modified image is usable for printing and cutting.

19. A server, comprising:
a processor;
a wide area network port coupled to the processor, configured to provide wide area network access for the server;
a memory medium coupled to the processor, wherein the memory medium stores program instructions, wherein the program instructions are executable by the processor to:
receive an original image over the wide area network from a client computer;
draw versions of the image over the original image, wherein the versions of the image are translated relative to the original image, wherein the original image is unmodified with respect to any overlapping portions of the versions of the image, and wherein said drawing produces a modified image;
store the modified image, wherein the modified image is usable for printing and/or cutting.

20. The server of claim 19, wherein the program instructions are further executable by the processor to:
print the modified image using a printer coupled to the server.

21. The server of claim 20, wherein the program instructions are further executable by the processor to:
cut the modified image along the border of the original image using a cutting device coupled to the server.
